(19) United States
(12) Patent Application Publication
(10) Pub. No.: US 2005/0135481 A1
(43) Pub. Date: Jun. 23, 2005

(54) Motion estimation with scalable searching range

(76) Inventor: Chih-Ta Star Sung, Glonn (DE)

Correspondence Address: Chih-Ta Star Sung;RM. 308, BLD. 52, NO. 195, CHUNG HSING RD., SEC. 4, CHU TUNG TOWNSHIP, HSINCHU COUNTY, 310, TW

(21) Appl. No.: 10/737,094

(22) Filed: Dec. 17, 2003

(51) Int. Cl. H04N 7/12

(52) U.S. Cl. 375/240.16; 375/240.12; 375/240.24

(57) ABSTRACT

An efficient motion estimation with an accurate starting point prediction and a scalable searching range is disclosed. A storage device saving MVs and SADs of an entire frame of the nearest neighboring frame and surrounding blocks is implemented. The majority or an average of MVs of the surrounding blocks and the corresponding position of at least one nearest neighboring frame is selected to be the starting point of the best match block full search. A threshold value is determined to early stop the calculation of the best match block search. Depending on the MV values of the surrounding blocks and a corresponding block in a nearest neighboring frame, pixels within a calculated scalable searching range are moved into a smaller on-chip searching range buffer from a larger reference frame buffer.

### BACKGROUND OF THE INVENTION

1. Field of Invention

The present invention is related to digital video compression, and more specifically, to an efficient motion estimation method with a fast memory buffer pixel data accessing that results in the saving of time of moving pixel data from a larger buffer to the motion estimator.

2. Description of Related Art

Digital video has been adopted in an increasing number of applications, which include video telephony, video conferencing, surveillance system, VCD (Video CD), DVD, and digital TV. In the past almost two decades, ISO and ITU have separately or jointly developed and defined some digital video compression standards including MPEG-1, MPEG-2, MPEG-4, MPEG-7, H.261, H.263 and H.264. The success of development of the video compression standards fuels the wide applications. The advantage of image and video compression techniques significantly saves the storage space and transmission time without sacrificing much of the image quality.

Most ISO and ITU motion video compression standards adopt Y, Cb and Cr as the pixel elements, which are derived from the original R (Red), G (Green), and B (Blue) color components. The Y stands for the degree of “Luminance”, while the Cb and Cr represent the color difference been separated from the “Luminance”. In both still and motion picture compression algorithms, the 8×8 pixels “Block” based Y, Cb and Cr go through the similar compression procedure individually.

Since the motion estimation consumes most computing power in the video compression procedure, the speed up of the motion estimation benefits in the total video compression performance enhancement. Bad or inaccurate measurement of the motion vector, the MV, results in larger differences between the targeted macroblock and the so called “best match” macroblock to cause higher bit rate of the compressed bit stream. A higher bit rate causes longer time in transmitting the data and requires more storage device to save the data. A commonly used method of reducing the bit rate is to quantize the DCT coefficients by using coarser quantization scales, which will more or less degrade the image quality and trigger more artifacts. Therefore, the compression performance, image quality and bit rate, are mostly likely conflicting requirements in video compression and becomes tradeoffs in the video compression system design.

In most prior arts of the motion estimation, the searching range is fixed once the frame size or said the resolution is decided. For instance, said +16 pixels, −15 pixels in X-axis and Y-axis directions. Once the searching range is defined, all blocks within all frames on a video sequence follow the same searching range and move all pixels within the searching range into an on-chip pixel buffer which is use to temporarily store pixels of searching range for each macroblock best match searching. This kind of pixels' moving and storage with fixed searching range cost a lot of times of moving pixels and very often become critical in timing since moving data from off-chip costs much longer time due to the factor that the system board has much higher capacitive loading than an on-chip data path loading. Some times, the whole encoder stops operating caused by the factor of running out of pixels data in the searching range during motion estimation because of slow searching range pixels moving. This degrades the encoding efficiency and causes bad image quality.

### SUMMARY OF THE INVENTION

Most motion estimation algorithms require about 50%-60% of the total computing power of the video stream encoding. Accurate prediction of the starting point of searching determines the time of the best match block searching. Allocating pixels of a searching range from an off-chip frame buffer into an on-chip buffer is very time consuming. The present invention is related to a method and apparatus of an efficient motion estimation with accurate starting point prediction and efficient means of allocating pixels within a searching range, which plays an important role in the reduction of time in the motion estimation.

According to an embodiment of this invention, a starting point of the best match block searching is the majority of the surrounding blocks plus the corresponding block of previous frame.

According to an embodiment of this invention, when no any two motion vectors are equal, a starting point of best match searching is the sum of the weighted factors of the surrounding blocks and the corresponding block of previous frame.

According to an embodiment of this invention, a starting point of the X-axis is the majority of the upper two rows' macroblocks and the corresponding macroblocks of previous frame or a sum of the weighted factors of the upper two macroblocks and the corresponding macroblocks of the previous frame.

According to an embodiment of this invention, a starting point of the Y-axis is the majority of the left two macroblocks and the corresponding macroblocks of the previous frame or a sum of the weighted factors of the left two macroblocks and the corresponding block of previous frame.

According to an embodiment of this invention, a starting point of the X-axis is the interpolated position of the upper two macroblocks' motion vectors is if these two MVs are not equal, while the Y-axis is the interpolated point of left two macroblocks' motion vectors if these two MV are not equal.

According to an embodiment of this invention, a starting point of the X-axis is the interpolated position of the two MVs of the corresponding position in the previous two frames if no equivalent blocks in surrounding macroblocks.

According to an embodiment of this invention, an early stop mechanism is applied to limit the time of calculation.

According to another embodiment of this invention, a threshold value is predetermined for the reference of the early stop decision in the step of full searching to limit the time of calculation.

According to another embodiment of this invention, the threshold value predetermined to early stop the calculation is the smallest value of the motion vectors of the surrounding macroblocks and the corresponding macroblock of the previous frame.

According to an embodiment of this invention, a scalable searching range is determined by comparing motion vectors, MVs of previous frame and surrounding blocks.

According to another embodiment of this invention, the pixels of a scalable searching range are moved from an off-chip frame buffer to an on-chip buffer which significantly reduces the time of allocating pixel data compared to a fixed larger searching range.

According to another embodiment of this invention, the procedures and steps of quickly determining the scalable searching range in the motion estimation is done by comparing MVs of previous frame, top and and left blocks.

According to an embodiment of this invention, the searching distance of X-axis and Y-axis directions of the searching range are dependent on the slope of the corresponding MVs. The larger value of each direction of the MV the larger the searching distance will be.

According to an embodiment of this invention, the slope of the MV to decides the ratio of X-axis and Y-axis of the searching range and moves the pixel of the decided searching range from a frame buffer into the on-chip block buffer.

According to an embodiment of this invention, the motion estimator incorporates a pipelining scheme moving the next 16×16 pixels into a buffer while calculating an SAD of the current macroblock.

It is to be understood that both the foregoing general description and the following detailed description are by examples, and are intended to provide further explanation of the invention as claimed.

### BRIEF DESCRIPTION OF THE DRAWINGS

FIG. 1 shows three basic types of the MPEG video frame coding including I-frame, P-frame and B-frame.

FIG. 2 is a brief block diagram of the prior art video compression encoder, which is conventionally used in most MPEG encoder system.

FIG. 3 is an illustration of the best match macroblock searching from the previous frame and the next frame. The concept of the searching range is also depicted in this figure.

FIG. 4A illustrates a means of starting point prediction of the motion estimation by using the upper and left macroblocks as references.

FIG. 4B shows the motion vectors of a GOB, group of block.

FIG. 4C illustrates a means of prediction combining the upper blocks, left block and the corresponding block of previous frame.

FIG. 4D depicts a means of starting point prediction with temporal vector of the MV change from previous two frames.

FIG. 5 illustrates the scalable searching range with variable searching distances of the X-axis and Y-axis directions.

FIG. 6 illustrates the block diagram of the motion estimation with the scalable searching range and data flow from off-chip frame buffer to the pixel buffer within the motion estimation.

FIG. 7 illustrates the movement of the next searching position.

### DESCRIPTION OF THE PREFERRED EMBODIMENTS

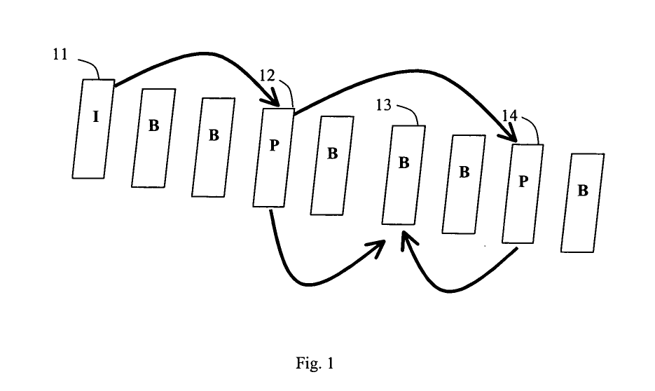

There are essentially three types of picture coding in the MPEG video compression standard as shown in FIG. 1. I-frame 11, the “Intra-coded” picture, uses the block of 8×8 pixels within the frame to code itself. P-frame 12, the “Predictive” frame, uses previous I-frame or P-frame as a reference to code the differences between frames. B-frame 13, the “Bi-directional” interpolated frame, uses previous I-frame or P-frame 12 as well as the next I-frame or P-frame 14 as references to code the pixel information. In the I-frame coding, all “Block” with 8×8 pixels go through the same compression procedure that is similar to JPEG, the still image compression algorithm. At the same time, the P-frame and B-frame have to code the differences between the targeted frame and the reference frames.

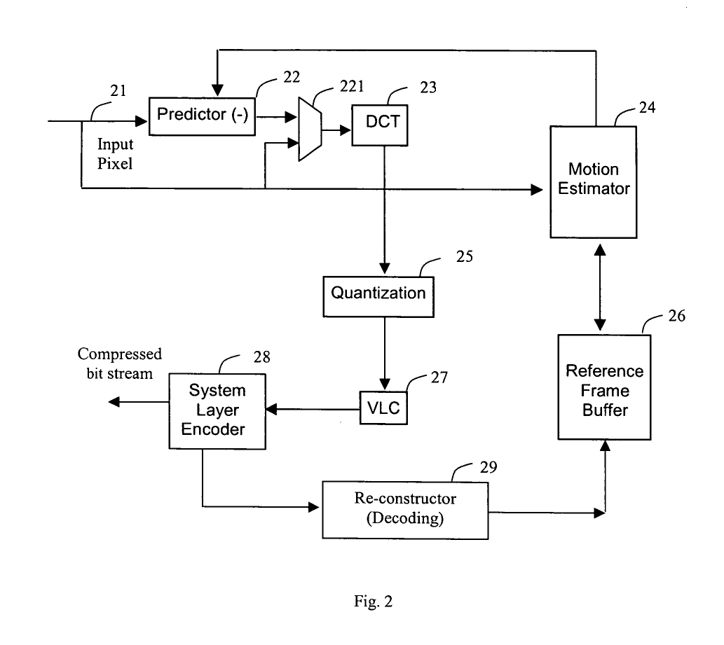

FIG. 2 shows a prior art block diagram of the MPEG video compression, which is most commonly adopted by video compression IC and system suppliers. In the case of I-frame or I-type macro block coding, the MUX 221 selects the coming pixels 21 to directly go to the DCT 23 block, the Discrete Cosine Transform before the Quantization 25 step. The quantized DCT coefficients are packed as pairs of “Run-Length” code, which has patterns that will later be counted and be assigned code with variable length by the VLC encoder 27. The Variable Length Coding depends on the pattern occurrence. The compressed I-frame bit stream will then be reconstructed by the reverse route of compression procedure 29 and be stored in a reference frame buffer 26 as future frames' reference. In the case of a P-frame, B-frame or a P-type, or a B-type macro block coding, the macro block pixels are sent to the motion estimator 24 to compare with pixels within macroblock of previous frame for the searching of the best match macroblock. The Predictor 22 calculates the pixel differences between the targeted 8×8 block and the block within the best match macroblock of previous frame or next frame if B-type frame. The block difference is then fed into the DCT 23, quantization 25, and VLC 27 coding, which is the same procedure like the I-frame or I-type macroblock coding.

In the coding of the differences between frames, the first step is to find the difference of the targeted frame, followed by the coding of the difference. For some considerations including accuracy, performance, and coding efficiency, in some video compression standards, a frame is partitioned into macroblocks of 16×16 pixels to estimate the block difference and the block movement. Each macroblock within a frame has to find the “best match” macroblock in the previous frame or in the next frame. The mechanism of identifying the best match macroblock is called “Motion Estimation”.

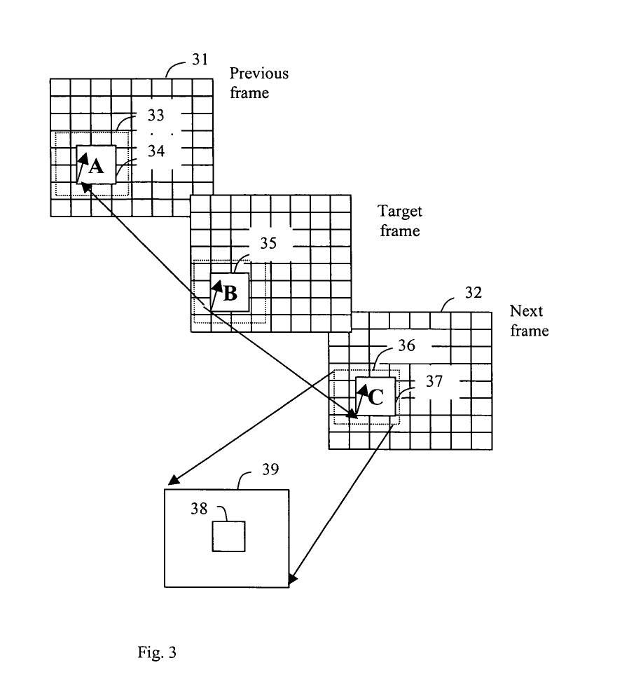

Practically, a block of pixels will not move too far away from the original position in a previous frame, therefore, searching for the best match block within an unlimited range of region is very time consuming and unnecessary. A limited searching range is commonly defined to limit the computing times in the “best match” block searching. The computing power hungered motion estimation is adopted to search for the “Best Match” candidates within a searching range for each macro block as described in FIG. 3. According to the MPEG standard, a macro block is composed of four 8×8 “blocks” of “Luma (Y)” and one, two, or four ““Chroma (Cb and Cr)”. Since Luma and Chroma are closely associated, in the motion estimation, only Luma needs the mostion estimation, and the Chroma, Cb and Cr in the corresponding position copy the same MV of Luma. The Motion Vector, MV, represents the direction and displacement of the block movement. For example, an MV=(5, −3) stands for the block movement of 5 pixels right in X-axis and 3 pixel down in the Y-axis. Motion estimator searches for the best match macroblock within a predetermined searching range 33, 36. By comparing the mean absolute differences, MAD or sum of absolute differences, SAD, the macroblock with the least MAD or SAD is identified as the “best match” macroblock. Once the best match blocks are identified, the MV between the targeted block 35 and the best match blocks 34, 37 can be calculated and the differences between each block within a macro block are coded accordingly. This kind of block difference coding technique is called “Motion Compensation”.

The Best Match Algorithm, BMA, is the most commonly used motion estimation algorithm in the popular video compression standards like MPEG and H.26x. In most video compression systems, motion estimation consumes high computing power ranging from ˜50% to ˜80% of the total computing power for the video compression. In the search for the best match macroblock, a searching range, for example ±16 pixels in both X- and Y-axis, is most commonly defined. The mean absolute difference, MAD or sum of absolute difference, SAD as shown below, is calculated for each position of a macroblock within the predetermined searching range, for example, a ±16 pixels of the X-axis

$$SAD ( x , y ) = {\sum }_{i = 0}^{15} {\sum }_{j = 0}^{15} \vert {V}_{n} ( x + i , y + j ) - {V}_{m} ( x + ⅆ x + i , y + ⅆ y + j ) \vert$$

$$MAD ( x , y ) = \frac{1}{256} {\sum }_{i = 0}^{15} {\sum }_{j = 0}^{15} \vert {V}_{n} ( x + i , y + j ) - {V}_{m} ( x + ⅆ x + i , y + ⅆ y + j ) \vert$$

and Y-axis. In above MAD and SAD equations, the Vn and Vm stand for the 16×16 pixel array, i and j stand for the 16 pixels of the X-axis and Y-axis separately, while the dx and dy are the change of position of the macroblock. The macroblock with the least MAD (or SAD) is from the BMA definition named the “Best match” macroblock. FIG. 3 depicts the best match macroblock searching and the depiction of the searching range. A motion estimator searches for the best match macroblock within a predetermined searching range 33, 36, 39 by comparing the mean absolute difference, MAD, or sum of absolute differences, SAD. The macroblock of a certain of position having the least MAD or SAD is identified as the “best match” macroblock. Once the best match blocks are identified, the MV between the targeted block 35 and the best match blocks 34, 37 can then be calculated and the differences between each block within a macro-block can be coded accordingly This kind of block difference coding technique is called “Motion Compensation”. The calculation of the motion estimation consumes most computing power in most video compression systems.

In the best match macroblock searching, an accurate prediction of the starting point is a key of quick identifying the best mach block. Many prediction algorithms have been developed in the past decade. Most of them apply one algorithm to all blocks and even to all frames in a video sequence.

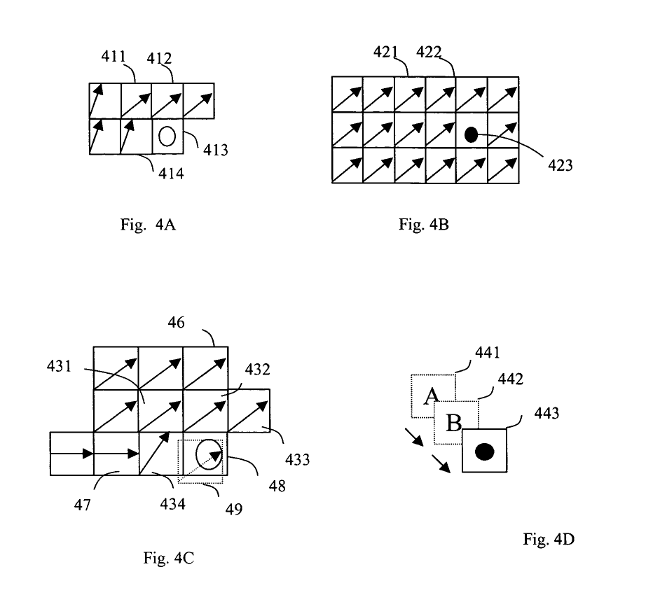

FIG. 4A illustrates prior art starting point prediction mode which uses motion vectors of the four surrounding macroblocks, in top row 411, 412, 413 and the left row 414 to predict the starting point of the best match block searching. The starting point follows the majority or the average of the four surrounding macroblocks' motion vectors.

According to one of the embodiment of the present invention, an adaptive means of starting point prediction is applied for more quickly identifying the best match block. FIG. 4B shows one of the prediction approaches in present invention. It is obvious that a group of blocks (GOB), 421, 422 have high possibility of having the same motion vectors and the starting point of the motion estimation of a target macroblock 423 is also the same position of MV of the GOB.

FIG. 4C demonstrates another means of the starting point prediction in the present invention. The starting point follows the majority of the four surrounding macroblocks, 431, 432, 433, 434 and the MV of the corresponding position 49 in previous frame. If no two identical MVs within the four surrounding macroblocks, then the starting point of X-axis and Y-axis will be predicted separately. Under this condition, the starting point of X-axis will be the majority or the average of the upper macroblocks in upper two rows 46, 432 and the corresponding position 49 of previous frame. While the starting point of Y-axis will be the majority or the average of the upper macroblocks in left two macroblocks 47, 434 and the corresponding position 49 of previous frame.

FIG. 4C also demonstrates another starting point prediction which is an average of motion vectors of the corresponding position of the previous frame, top block and left block of the current frame. Statistically, the movement of a block of the corresponding block within a previous frame has almost equal probability of motion vector compared to the left block or top block of the current frame since temporal and spatial movement is considered the same probability.

FIG. 4D shows another starting point prediction which is an interpolated point of the corresponding position of the previous two frames. This kind of prediction assumes that the temporal movement dominates the change of the block pixels movement and the momentum of the temporal movement has high possibility of continuity. So, the starting point of a target macroblock 443 of present frame follows the interpolated position of the MV of the corresponding macroblocks 441, 442 of the closest previous two frames.

After identifying the starting point, the motion estimation goes through a thorough searching for the best match macroblock. This procedure is named “full search”. For saving times of calculation, according to an embodiment of the present invention, a threshold value is predetermined for each macroblock to early stop the calculation of the best match macroblock searching when the SAD of a certain position is below the threshold value. The threshold value of this present invention is determined by selecting the smallest SAD values of the four surrounding blocks. This kind of mechanism ensures the reduction of a certain amount of calculation times.

In most prior arts of the motion estimation, no matter what searching algorithm, the best match block searching range is fixed once the frame size or said the resolution is decided. For instance, said +16 pixels (right/top direction), −15 pixels (left/bottom direction) in X-axis and Y-axis directions in CIF(352×288 pixels) resolution, or said +32 pixels right (right/top direction), −31 pixels (left/bottome direction), in X-axis and Y-axis directions in D1(720×480 pixels) resolution. Once the searching range is defined, all blocks within all frames in a video sequence adopt the same searching range and move all pixels within the searching range from a larger storage device, said a frame buffer into an on-chip pixel buffer which is use to temporarily store pixels of searching range for each macroblock best match searching. This kind of pixels' moving and storage with fixed searching range cost a lot of times of moving pixels and very often become critical in timing since moving data from off-chip costs much longer time due to the factor that the system board has much higher capacitive loading than an on-chip data path loading. Sometimes, the whole encoder stops operating caused by the factor of running out of pixels data in the searching range buffer during motion estimation because of slow searching range pixels moving. This degrades the encoding efficiency and causes bad image quality.

The present invention overcomes the pixel moving speed from a frame buffer to the searching range pixel buffer in the motion estimation with scalable searching range for the search of the best match macroblock. The method and apparatus quickly identifies the best match macroblock and efficiently determines the searching range and moves pixel data from a larger frame buffer into a searching range pixel buffer for the search of the best match block, which results in a significant saving of time of moving pixels.

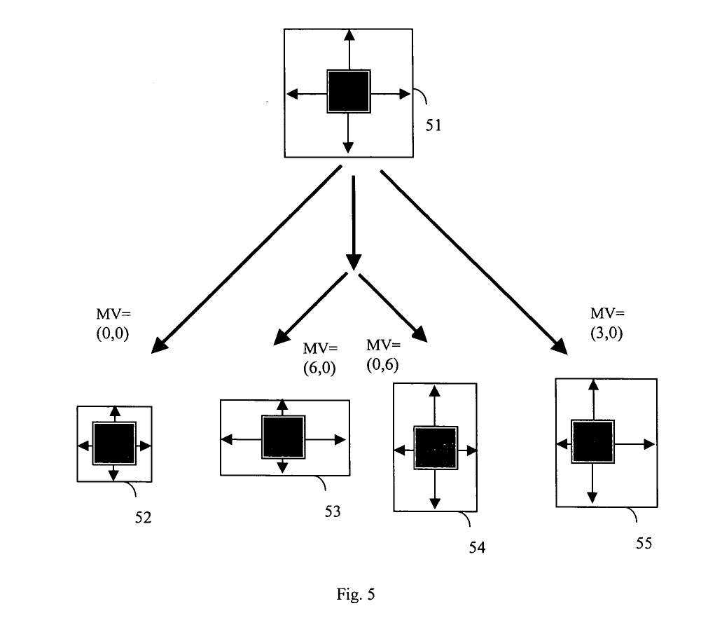

According to an embodiment of the present invention, once the frame size is known, a searching range 51 with a maximum pixel amount is decided as shown in FIG. 5. The searching range can in the worst case store a maximum of surrounding pixels of a target macroblock for the best match macroblock searching. A macroblock with no movement, MV=[0,0] or the MV is the same with the frame's motion vector, FMV of the previous frame will have higher probability of finding the best match macroblock within a smaller distance from the original point if MV=[0,0] or the point of FMV. Therefore, pixels within a shorter distance of the searching range 52 will be identified and moved to the on-chip searching range buffer from an larger off-chip frame buffer. A macroblock with a predicted starting point of larger distance in X-axis and smaller distance in Y-axis, for example, [6,0] will have high probability of finding the best match macroblock within a larger distance in X-axis and probably smaller distance in Y-axis and pixels within larger distance in X-axis and smaller distance of Y-axis 53 will be moved to the searching range pixel buffer from a larger off-chip frame buffer accordingly. In the other hand, A macroblock with a predicted starting point of larger distance in Y-axis and smaller distance in X-axis, for example, [0,6] will have high probability of finding the best match macroblock within a larger distance in Y-axis and probably smaller distance in X-axis and pixels within larger distance in Y-axis and smaller distance of X-axis 54 will be moved to the searching range pixel buffer from a larger off-chip frame buffer. In some fast moving momentum, when a higher predicted direction of the movement, a limited range with “unbalanced” shape of searching range might be feasible in identifying the best match macroblock, for instance a predicted starting point of [5,0], but higher probability of best match macroblock falls in the positive X-axis direction, pixels of a larger distance of +X axis and shorter distance from −X direction 55 will be moved to the searching range pixel buffer from a larger off-chip frame buffer.

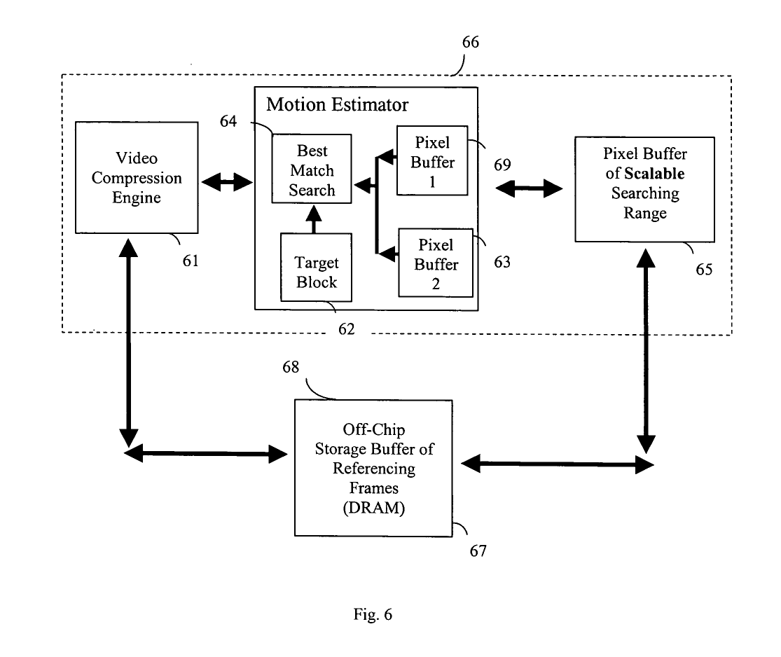

FIG. 6 depicts the brief block diagram of the implementation of the motion estimation with the searching range pixel buffer. Pixels of the predicted searching range are moved to the pixel buffer 65 from the off-chip frame buffer 67. There are two 16×16 pixels so named ping-pong buffer 69, 63 for temporarily storing the pixels for SAD calculation in motion estimation. When the best match search engine 68 is calculating the SAD value between a target block 62 and a block within the previous frame or a next frame (if B-type frame coding), the best match searching engine is accessing one 16×6 pixel ping-pong buffer, and the other 16×16 pixel ping-pong buffer is accessing the larger on-chip scalable pixel buffer 65 for transferring the 16×16 pixels to get ready for the next point SAD calculation of the best match searching. When the best match block is identified, the 16×16 pixel differences of target block and the best match block are sent to the video compression engine 61 to go through other procedure of the video compression.

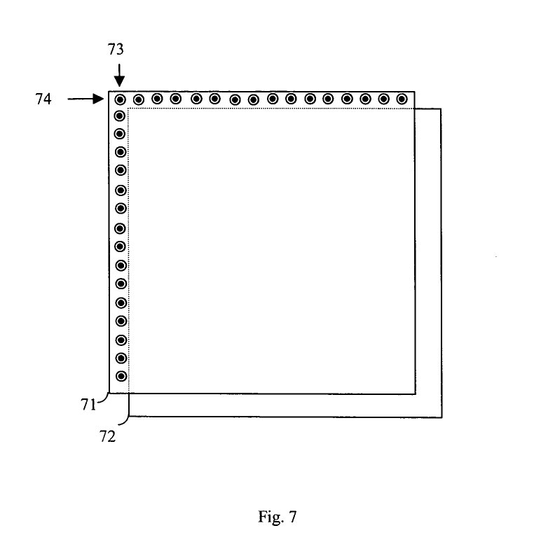

According to another embodiment if the present invention, for saving time of allocating new pixels from an off-chip referencing frame buffer, only a limited amount of pixels which are not within the searching range buffer of previous searching position need to be moved. FIG. 7 illustrates the conceptual means of an example of moving pixels of a new row 74 or a new column 73 according to the new position 71 of searching range moving from an old position 72. Since most pixels within the searching range are the same with different location correspondingly, there is only a need to change the location pointer position to indicate the location of each pixel.

Summary: The present invention of the motion estimation with a scalable searching range significantly saves the times of best match macroblock searching by applying accurate starting point prediction and the means of threshold value setting to early stop the calculation. This present invention also significantly reduces the time needed to move pixels of the searching range to the searching range buffer from an off-chip frame buffer memory by moving only limited and predicted scalable searching range of pixels.

It will be apparent to those skills in the art that various modifications and variations can be made to the structure of the present invention without departing from the scope or the spirit of the invention. In the view of the foregoing, it is intended that the present invention covers modifications and variations of this invention provided fall within the scope of the following claims and their equivalents.

1. A method for motion estimation comprising:
saving motion vectors, MVs of at least one frame into a storage device for the starting point calculation in motion estimation;
calculating a starting point for a best match block searching by firstly searching a majority of MVs of the surrounding macroblocks and a corresponding macroblocks of at least one nearest neighboring frame; and
calculating the starting point of a best match block searching by firstly taking an average of MVs of the surrounding macroblocks and a corresponding macroblocks of at least one neighboring frame for X-axis and Y-axis movement if no two MVs have the same value.

2. The method of claim 1, wherein the majority of MVs of the top three blocks of an upper row and the left block and the corresponding block of a nearest previous frame is selected to be the starting point in full search.

3. The method of claim 1, wherein when no two identical blocks are identified, the starting point in X-axis is the majority of the X-axis values of the MVs of the top two blocks in upper two rows and the corresponding block of the nearest frame.

4. The method of claim 3, wherein when no two identical X-axis values are identified, the starting point in X-axis is the average of the X-axis values of the MVs of the top two blocks in upper two rows and the corresponding block of the nearest frame.

5. The method of claim 1, wherein when no two identical blocks are identified, the starting point in Y-axis is the majority of the Y-axis values of the MVs of the two blocks in left and the corresponding block of the nearest frame.

6. The method of claim 5, wherein when no two identical X-axis values are identified, the starting point in Y-axis is the average of the Y-axis values of the MVs of the two blocks in left and the corresponding block of the nearest frame.

7. A method for determining a threshold value for full searching, comprising:
saving sum of absolute mean, SADs of the best match block of at least one frame into a storage device for current frame's reference in more accurately predicting the possible value of an SAD;
saving sum of absolute mean, SADs of the best match block of at least one block of upper row and at least one block in left into a storage device; and
selecting the minimum value of the SADs of the surrounding blocks and the corresponding block in the nearest frame to be the threshold value of full search to early stop the calculation of best match searching.

8. The method of claim 7, wherein when SAD of a present position is calculated, the SAD is compared to the minimum of the SADs of surrounding blocks and the corresponding block in the nearest frame, if the SAD of the present position is smaller, then the present position is identified as the best match block.

9. A method for allocating a scalable searching range of pixels for motion estimation, comprising:
saving motion vectors, MVs of at least one frame into a storage device for the starting point calculation in motion estimation;
calculating a starting point for a best match block searching by firstly searching a majority of MVs of the surrounding macroblocks and a corresponding macroblocks of at least one nearest neighboring frame; and
deciding a searching range of a target block by comparing MVs of the surrounding macroblocks and a corresponding macroblock of at least a neighboring frame; And
allocating pixels of a determined searching range to the searching range buffer.

10. The method of claim 9, wherein a scalable searching range is determined by comparing the MVs of the surrounding maccroblocks and a corresponding position in the nearest frame.

11. The method of claim 9, wherein the searching distance of X-axis and Y-axis directions of the scalable searching range are dependent on the slope of the MVs of the surrounding macroblocks and the corresponding position of the nearest frame. The larger the value of each direction of the MV the larger the searching distance will be.

12. The method of claim 11, wherein the smaller the MV values of the surrounding macroblocks, the smaller amount of pixels of the searching range will be moved to the on-chip searching range buffer from the larger frame buffer.

13. The method of claim 9, wherein the motion estimator incorporates a pipelining scheme moving the next 1 6×16 pixels into a buffer while calculating an SAD of the current macroblock stored in another 16×16 pixel buffer.

14. The method of claim 9, wherein once a new starting point and a searching range is determined, allocating at least one new row of pixels which are not reside in the previous searching range buffer into the newly determined searching range buffer from a bigger buffer.

15. The method of claim 9, wherein once a new starting point and a searching range is determined, allocating at least one new column of pixels which are not reside in the previous searching range buffer into the newly determined searching range buffer from a bigger buffer.
